(19) United States
(12) Patent Application Publication
(10) Pub. No.: US 2009/0220399 A1
(43) Pub. Date: Sep. 3, 2009

(54) Tetraorganoammonium and tetraorganophosphonium salts for acid gas scrubbing process

(76) Inventors: Frank Cheng-Yu Wang, Annandale, NJ (US); Michael Siskin, Westfield, NJ (US)

Correspondence Address: ExxonMobil Research & Engineering Company, P.O. Box 900, 1545 Route 22 East, Annandale, NJ, 08801-0900, US

(21) Appl. No.: 11/989,155

(22) PCT Filed: Jul. 21, 2006
(86) PCT No.: PCT/US06/28687

§ 371 Date: Apr. 27, 2009

Related U.S. Application Data
(60) Provisional application No. 60/706,616, filed on Aug. 9, 2005.

(51) Int. Cl. B01D 53/52; B01J 20/22

(52) U.S. Cl. 423/223; 502/401; 423/228

(57) ABSTRACT

Tetraorganoammonium and tetraorganophosphonium salts are useful as absorbents for the selective removal of acidic components from mixtures of said acidic components and CO₂.

### BACKGROUND OF THE INVENTION

1. Field of the Invention

The present invention relates to an absorbent composition and to a process for the selective absorption of acidic components such as H₂S, carbon disulfide, carbonyl sulfide, oxygen and sulfur derivatives of C₁-C₄ hydro-carbons, hydrogen cyanide, etc., from normally gaseous mixtures containing such acidic components and components such as CO₂.

2. Description of the Related Art

It is well known in the art to treat gases and liquids, such as mixtures containing acidic gases including CO₂, H₂S, CS₂, HCN, COS and oxygen and sulfur derivatives of C₁ to C₄ hydrocarbons with amine solutions to remove these acidic components. The amine usually contacts the acidic gases and liquids as an aqueous solution containing the amine in an absorber tower with the aqueous amine solution contacting the acidic fluid countercurrently.

The treatment of acid gas mixtures containing, inter alia, CO₂ and H₂S with amine solutions typically results in the simultaneous removal of substantial amounts of both the CO₂ and H₂S. For example, in one such process generally referred to as the “aqueous amine process”, relatively concentrated amine solutions are employed. A recent improvement of this process involves the use of sterically hindered amines as described in U.S. Pat. No. 4,112,052, to obtain nearly complete removal of acid gases such as CO₂ and H₂S. This type of process may be used where the partial pressures of the CO₂ and related gases are low. Another process often used for specialized applications where the partial pressure of CO₂ is extremely high and/or where many acid gases are present, e.g., H₂S, COS, CH₃SH and CS₂ involves the use of an amine in combination with a physical absorbent, generally referred to as the “nonaqueous solvent process”. An improvement on this process involves the use of sterically hindered amines and organic solvents as the physical absorbent such as described in U.S. Pat. No. 4,112,051.

It is often desirable, however, to treat acid gas mixtures containing both CO₂ and H₂S so as to remove the H₂S selectively from the mixture, thereby minimizing removal of the CO₂. Selective removal of H₂S results in a relatively high H₂S/CO₂ ratio in the separated acid gas which simplifies the conversion of H₂S to elemental sulfur using the Claus process.

The typical reactions of aqueous secondary and tertiary amines with CO₂ and H₂S can be represented as follows:

H₂S+R₃N⇄R₃NH⁺+SH⁻ (1)

H₂S+R₂NH⇄R₂NH₂⁺+SH⁻ (2)

CO₂+R₃N+H₂O⇄R₃NH⁺+HCO₃⁻ (3)

CO₂+2R₂NH⇄R₂NH₂⁺+R₂NCOO⁻ (4)

RNH₂+CO₂⇄RN⁺H₂CO₂⁻ (5)

RN⁺H₂CO₂+RNH₂⇄RNHCO₂⁻RNH₃⁺ (6)

wherein each R is an organic radical which may be the same or different and may be substituted with a hydroxy group. The above reactions are reversible, and the partial pressures of both CO₂ and H₂S are thus important in determining the degree to which the above reactions occur.

While selective H₂S removal is applicable to a number of gas treating operations including treatment of hydrocarbon gases from shale pyrolysis, refinery gas and natural gas having a low H₂S/CO₂ ratio, it is particularly desirable in the treatment of gases wherein the partial pressure of H₂S is relatively low compared to that of CO₂ because the capacity of an amine to absorb H₂S from the latter type gases is very low. Examples of gases with relatively low partial pressures of H₂S include synthetic gases made by coal gasification, sulfur plant tail gas and low-Joule fuel gases encountered in refineries where heavy residual oil is being thermally converted to lower molecular weight liquids and gases.

Although it is known that solutions of primary and secondary amines such as monoethanolamine (MEA), diethanolamine (DEA), dipropanolamine (DPA), and hydroxyethoxyethylamine (DGA) absorb both H₂S and CO₂ gas, they have not proven especially satisfactory for preferential absorption of H₂S to the exclusion of CO₂ because the amines undergo a facile reaction with CO₂ to form carbamates see Equations (5) and (6).

Diisopropanolamine (DIPA) is relatively unique among secondary aminoalcohols in that it has been used industrially, alone or with a physical solvent such as sulfolane, for selective removal of H₂S from gases containing H₂S and CO₂, but contact times must be kept relatively short to take advantage of the faster reaction of H₂S with the amine compared to the rate of CO₂ reaction shown in Equations 2 and 4 hereinabove.

In 1950, Frazier and Kohl, Ind. and Eng. Chem., 42, 2288 (1950) showed that the tertiary amine, methyldiethanolamine (MDEA), has a high degree of selectivity toward H₂S absorption over CO₂. This greater selectivity was attributed to the relatively slow chemical reaction of CO₂ with tertiary amines as compared to the rapid chemical reaction of H₂S. The commercial usefulness of MDEA, however, is limited because of its restricted capacity for H₂S loading and its limited ability to reduce the H₂S content to the level at low pressures which is necessary for treating, for example, synthetic gases made by coal gasification.

Recently, U.K. Patent Publication No. 2,017,524A to Shell disclosed that aqueous solutions of dialkylmonoalkanolamines, and particularly diethyl-monoethanolamine (DEAE), have higher selectivity and capacity for H₂S removal at higher loading levels than MDEA solutions. Nevertheless, even DEAE is not very effective for the low H₂S loading frequency encountered in the industry. Also, DEAE has a boiling point of 161° C., and as such, it is characterized as being a low-boiling, relatively highly volatile amino alcohol. Such high volatilities under most gas scrubbing conditions result in large material losses with consequent losses in economic advantages.

U.S. Pat. Nos. 4,405,581; 4,405,583 and 4,405,585 disclose the use of severely sterically hindered amine compounds for the selective removal of H₂S in the presence of CO₂. Compared to aqueous methyldiethanolamine (MDEA) severely sterically hindered amines lead to much higher selectivity at high H₂S loadings.

U.S. Pat. No. 4,892,674 is directed to an absorbent composition comprising an alkaline absorbent solution containing a non-hindered amine and an additive of a severely-hindered amine salt and/or a severely-hindered amino acid and to the use of the absorbent for the selective removal of H₂S from gaseous streams. The amine salt is the reaction product of an alkaline severely hindered amino compound and a strong acid or a thermally decomposable salt of a strong acid, i.e., ammonium salt. Suitable strong acids include inorganic acids such as sulfuric acid, sulfurous acid, phosphoric acid, phosphorous acid, pyrophosphoric acid; organic acids such as acetic acid, formic acid, adipic acid, benzoic acid, etc. Suitable salts include the ammonium salts, for example, ammonium sulfate, ammonium sulfite, ammonium phosphate and mixtures thereof.

### DESCRIPTION OF THE FIGURE

FIG. 1 is a diagrammatic flow sheet illustrating an absorption regeneration unit for the selective removal of H₂S from gaseous streams containing H₂S and CO₂.

### SUMMARY OF THE INVENTION

The present invention is directed to an absorbent comprising one or more basic tetraorganoammonium salt, basic tetraorganophosphonium salt or mixtures thereof and the use of such absorbent in an acid gas treating process.

### DETAILED DESCRIPTION OF THE INVENTION

One or more tetraorganoammonium salts, one or more tetraorgano-phosphonium salts and mixtures of one or more tetraorganoammonium salts and one or more tetraorganophosphonium salts are selective absorbents for the acidic components of acid gases, including mixtures of H₂S, CS₂, HCN, COS, oxygen and sulfur derivatives of C₁-C₄ hydrocarbons from non-acidic components, and CO₂. The absorbents selectively remove H₂S and other acidic components from normally gaseous mixtures containing such acidic components in admixture with components such as CO₂, preferably the selective remove H₂S from mixtures of H₂S, CO₂ and other components.

The tetraorganoammonium salts and tetraorganophosphonium salts are generally of the formula

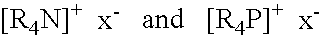

and more particularly

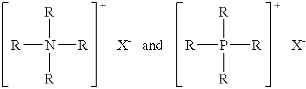

wherein X is hydroxide (OH⁻), carbonate (OCO₂⁼), carboxylate (R¹CO₂⁻), arylates [arylcarboxylates] (ArCOO⁻) wherein R¹ [or R′] is H or a C₁-C₉ substituted or unsubstituted alkyl, C₃-C₉ substituted or unsubstituted alkenyl, branched alkyl, branched alkenyl, C₃-C₉ (cycloalkyl), substituted or unsubstituted hydroxy alkyl or hydroxy cycloalkyl, Ar is C₆-C₁₄, preferably C₆-C₁₀ aryl, alkylaryl or arylalkyl radical, preferably phenyl, alkyl phenyl, naphthyl, alkyl naphthyl radical, and R is the same or different and selected from C₁-C₂₀ substituted or unsubstituted alkyl, C₂-C₂₀ substituted or unsubstituted alkenyl, C₃-C₂₀ substituted or unsubstituted branched chain alkyl, alkenyl, cyclic, cycloalkyl or cycloalkenyl, C₆-C₂₀ substituted or unsubstituted aryl, alkylaryl, arylalkyl, the substituents, if present, being oxygen containing functional groups, including hydroxyl (—OH), hydroxy alkyl (—R²OH), ether (—OR³ and —R²—O—R³),

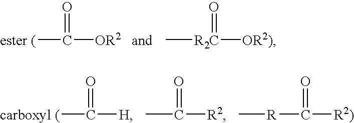

wherein R² and R³ are the same or different and are selected from C₁-C₉ substituted or unsubstituted alkyl, C₃-C₉ preferably C₅-C₆ substituted or unsubstituted cyclic, cyclo alkyl or cycloalkenyl radical C₃-C₉ straight or branched chain alkenyl, C₆-C₂₀ preferably C₆-C₁₂, more preferably C₆-C₁₀ substituted or unsubstituted aryl, alkylaryl or arylalkyl, the substituents being hetero atoms (O, N, S) located in the carbon backbone skeleton or heteroatom groups attached to the carbon backbone. Preferably the R, R¹, R² and R³ groups are unsubstituted.

The absorbents described above exhibit high selectivity for H₂S and other acidic components removal from mixtures of such acidic components, non-acidic components and CO₂ and retain their high selectivity and loading capacity even after regeneration.

The absorbents are utilized for the selective absorption of H₂S from a normally gaseous mixture containing H₂S and CO₂ comprising:
(a) contacting said normally gaseous mixture with an absorbent solution characterized as capable of selectively absorbing H₂S from said mixture;
(b) regenerating, at least partially, said absorbent solution containing H₂S; and
(c) recycling the regenerated solution for the selective absorption of H₂S by contacting as in step (a).
   Preferably, the regenerating step is carried out by heating and stripping and more preferably heating and stripping with steam.

The term “absorbent solution” as used herein includes but is not limited to solutions wherein the amino compound is dissolved in a solvent selected from water or a physical absorbent or mixtures thereof. Solvents which are physical absorbents (as opposed to the amino compounds which are chemical absorbents) are described, for example, in U.S. Pat. No. 4,112,051, the entire disclosure of which is incorporated herein by reference, and include, e.g., aliphatic acid amides, N-alkylated pyrrolidones, sulfones, sulfoxides, glycols and the mono- and diethers thereof. The preferred physical absorbents herein are sulfones, and most particularly, sulfolane. The preferred liquid medium comprises water.

The absorbent solution ordinarily has a concentration of amino compound of about 0.1 to 6 moles per liter of the total solution, and preferably 1 to 4 moles per liter, depending primarily on the specific amino compound employed and the solvent system utilized. If the solvent system is a mixture of water and a physical absorbent, the typical effective amount of the physical absorbent employed may vary from 0.1 to 5 moles per liter of total solution, and preferably from 0.5 to 3 moles per liter, depending mainly-on the type of amino compound being utilized. The dependence of the concentration of amino compound on the particular compound employed is significant because increasing the concentration of amino compound may reduce the basicity of the absorbent solution, thereby adversely affecting its selectivity for H₂S removal, particularly if the amino compound has a specific aqueous solubility limit which will determine maximum concentration levels within the range given above. It is important, therefore, that the proper concentration level appropriate for each particular amino compound be maintained to insure satisfactory results.

The solution of this invention may include a variety of additives typically employed in selective gas removal processes, e.g., antifoaming agents, antioxidants, corrosion inhibitors, and the like. The amount of these additives will typically be in the range that they are effective, i.e., an effective amount.

Also, the amino compounds described herein may be admixed with other amino compounds as a blend. The ratio of the respective amino compounds may vary widely, for example, from 1 to 99 wt % of the amino compounds described herein.

Three characteristics which are of ultimate importance in determining the effectiveness of the amino compounds herein for H₂S removal are “selectivity”, “loading” and “capacity”. The term “selectivity” as used throughout the specification is defined as the following mole ratio fraction:

$$\frac{( moles of {H}_{2} S \text{/} moles of {CO}_{2} ) in liquid phase}{( moles of {H}_{2} S \text{/} moles of {CO}_{2} ) in gaseous phase}$$

The higher this fraction, the greater the selectivity of the absorbent solution for the H₂S in the gas mixture.

By the term “loading” is meant the concentration of the H₂S and CO₂ gases physically dissolved and chemically combined in the absorbent solution as expressed in moles of gas per moles of the amine. The best amino compounds are those which exhibit good selectivity up to a relatively high loading level. The amino compounds used in the practice of the present invention typically have a “selectivity” of not substantially less than 10 at a “loading” of 0.1 moles, preferably, a “selectivity” of not substantially less than 10 at a loading of 0.2 or more moles of H₂S and CO₂ per moles of the amino compound.

“Capacity” is defined as the moles of H₂S loaded in the absorbent solution at the end of the absorption step minus the moles of H₂S loaded in the absorbent solution at the end of the desorption step. High capacity enables one to reduce the amount of amine solution to be circulated and use less heat or steam during regeneration.

The acid gas mixture herein necessarily includes H₂S, and may optionally include other gases such as CO₂, N₂, CH₄, H₂, CO, H₂O, COS, HCN, C₂H₄, NH₃, and the like. Often such gas mixtures are found in combustion gases, refinery gases, town gas, natural gas syn gas, water gas, propane, propylene, heavy hydrocarbon gases, etc. The absorbent solution herein is particularly effective when the gaseous mixture is a gas, obtained, for example, from a shale oil retort, coal liquefaction or gasification, gasification of heavy oil with steam, air/steam or oxygen/steam, thermal conversion of heavy residual oil to lower molecular weight liquids and gases, e.g., fluid coker, Flexicoker, or delayed coker, or in sulfur plant tail gas cleanup operations.

The absorption step of this invention generally involves contacting the normally gaseous stream with the absorbent solution in any suitable contacting vessel. In such processes, the normally gaseous mixture containing H₂S and CO₂ from which the H₂S is to be selectively removed may be brought into intimate contact with the absorbent solution using conventional means, such as a tower or vessel packed with, for example, rings or with sieve plates, or a bubble reactor. Other acidic gaseous components will also be removed.

In a typical mode of practicing the invention, the absorption step is conducted by feeding the normally gaseous mixture into the lower portion of the absorption tower while fresh absorbent solution is fed into the upper region of the tower. The gaseous mixture, freed largely from the H₂S, emerges from the upper portion of the tower, and the loaded absorbent solution, which contains the selectively absorbed H₂S, leaves the tower near or at its bottom. Preferably, the inlet temperature of the absorbent solution during the absorption step is in the range of from about 20° C. to about 100° C., and more preferably from 30° C. to about 60° C. Pressures may vary widely; acceptable pressures are between 5 and 2000 psia, preferably 20 to 1500 psia, and most preferably 25 to 1000 psia in the absorber. The contacting takes place under conditions such that the H₂S is selectively absorbed by the solution. The absorption conditions and apparatus are designed so as to minimize the residence time of the liquid in the absorber to reduce CO₂ pickup while at the same time maintaining sufficient residence time of gas mixture with liquid to absorb a maximum amount of the H₂S gas. The amount of liquid required to be circulated to obtain a given degree of H₂S removal will depend on the chemical structure and basicity of the amino compound and on the partial pressure of H₂S in the feed gas. Gas mixtures with low partial pressures such as those encountered in thermal conversion processes will require more liquid under the same absorption conditions than gases with higher partial pressures such as shale oil retort gases.

A typical procedure for the selective H₂S removal phase of the process comprises selectively absorbing H₂S via countercurrent contact of the gaseous mixture containing H₂S and CO₂ with the solution of the amino compound in a column containing a plurality of trays at a low temperature, e.g., below 45° C., and at a gas velocity of at least about 0.3 ft/sec (based on “active” or aerated tray surface), depending on the operating pressure of gas, said tray column having fewer than 20 contacting trays, with, e.g., 4-16 trays being typically employed.

After contacting the normally gaseous mixture with the absorbent solution, which becomes saturated or partially saturated with H₂S, the solution may be at least partially regenerated so that it may be recycled back to the absorber. As with absorption, the regeneration may take place in a single liquid phase. Regeneration or desorption of the absorbent solution may be accomplished by conventional means such as pressure reduction of the solution or increase of temperature to a point at which the absorbed H₂S flashes off, or bypassing the solution into a vessel of similar construction to that used in the absorption step, at the upper portion of the vessel, and passing an inert gas such as air or nitrogen or preferably steam upwardly through the vessel. The temperature of the solution during the regeneration step should be in the range from about 50° C. to about 170° C., and preferably from about 80° C. to 120° C., and the pressure of the solution on regeneration should range from about 0.5 to about 100 psia, preferably 1 to about 50 psia. The absorbent solution, after being cleansed of at least a portion of the H₂S gas, may be recycled back to the absorbing vessel. Makeup absorbent may be added as needed.

In the preferred regeneration technique, the H₂S-rich solution is sent to the regenerator wherein the absorbed components are stripped by the steam which is generated by re-boiling the solution. Pressure in the flash drum and stripper is usually 1 to about 50 psia, preferably 15 to about 30 psia, and the temperature is typically in the range from about 50° C. to 170° C., preferably about 80° C. to 120° C. Stripper and flash temperatures will, of course, depend on stripper pressure, thus at about 15 to 30 psia stripper pressures, the temperature will be about 80° C. to about 120° C. during desorption. Heating of the solution to be regenerated may very suitably be effected by means of indirect heating with low-pressure steam. It is also possible, however, to use direct injection of steam.

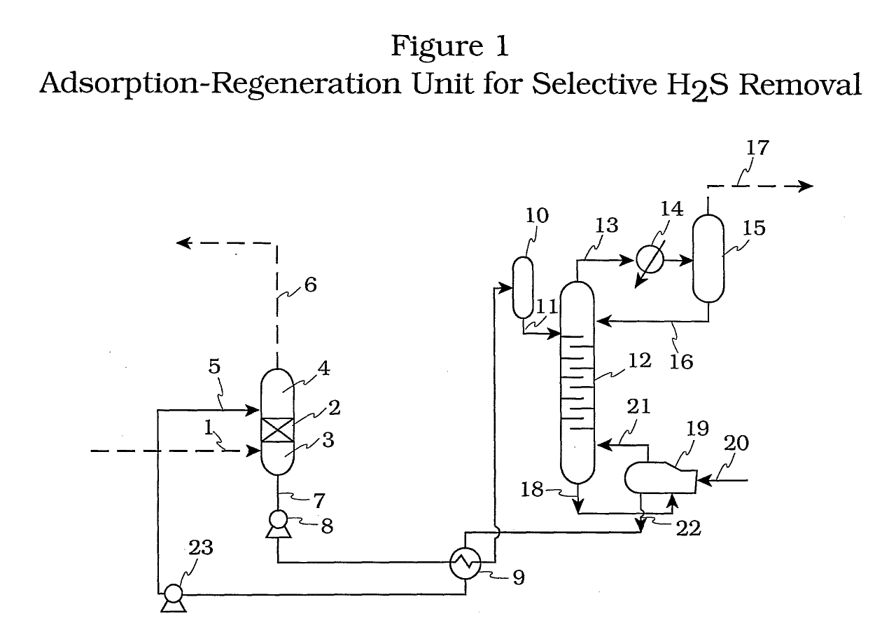

In one embodiment for practicing the entire process herein, as illustrated in FIG. 1, the gas mixture to be purified is introduced through line 1 into the lower portion of a gas-liquid countercurrent contacting column 2, said contacting column having a lower section 3 and an upper section 4. The upper and lower sections may be segregated by one or a plurality of packed beds as desired. The absorbent solution as described above is introduced into the upper portion of the column through a pipe 5. The solution flowing to the bottom of the column encounters the gas flowing countercurrently and dissolves the H₂S preferentially. The gas freed from most of the H₂S exits through a pipe 6, for final use. The solution, containing mainly H₂S and some CO₂, flow toward the bottom portion of the column, from which it is discharged through pipe 7. The solution is then pumped via optional pump 8 through an optional heat exchanger and cooler 9 disposed in pipe 7, which allows the hot solution from the regenerator 12 to exchange heat with the cooler solution from the absorber column 2 for energy conservation. The solution is entered via pipe 7 to a flash drum 10 equipped with a line (not shown) which vents to line 13 and then introduced by pipe 11 into the upper portion of the regenerator 12, which is equipped with several plates and effects the desorption of the H₂S and CO₂ gases carried along in the solution. This acid gas is passed through a pipe 13 into a condenser 14 wherein cooling and condensation of water and amine solution from the gas occur. The gas then enters a separator 15 where further condensation is effected. The condensed solution is returned through pipe 16 to the upper portion of the regenerator 12. The gas remaining from the condensation, which contains H₂S and some CO₂, is removed through pipe 17 for final disposal (e.g., to a vent or incinerator or to an apparatus which converts the H₂S to sulfur, such as a Claus unit or a Stretford conversion unit (not shown).

The solution is liberated from most of the gas which it contains while flowing downward through the regenerator 12 and exits through pipe 18 at the bottom of the regenerator for transfer to a reboiler 19. Reboiler 19, equipped with an external source of heat (e.g., steam injected through pipe 20 and the condensate exits through a second pipe (not shown)), vaporizes a portion of this solution (mainly water) to drive further H₂S therefrom. The H₂S and steam driven off are returned via pipe 21 to the lower section of the regenerator 12 and exited through pipe 13 for entry into the condensation stages of gas treatment. The solution remaining in the reboiler 19 is drawn through pipe 22, cooled in heat exchanger 9, and introduced via the action of pump 23 (optional if pressure is sufficiently high) through pipe 5 into the absorber column 2.

Typically, a gaseous stream to be treated having a 1:10 mole ratio of H₂S:CO₂ from an apparatus for thermal conversion of heavy residual oil, or a Lurgi coal gas having a mole ratio of H₂S:CO₂ of less than 1:10 will yield an acid gas having a mole ratio of H₂S:CO₂ of about 1:1 after treatment by the process of the present invention. The process herein may be used in conjunction with another H₂S selective removal process; however, it is preferred to carry out the process of this invention by itself, since the amino compounds are extremely effective by themselves in preferential absorption of H₂S.

### Experimental Procedure

1. Absorption tests were carried out at 35° C. on 0.15 M aqueous solutions of absorbent using a test gas mixture of nitrogen:carbon dioxide:hydrogen sulfide of 89:10:1 for 2 hours.
2. Desorption was run at 85° C. in N₂ for 2 hours at the same flow rate as the test gas mixture.

The results are presented in Table 1 below:

TABLE 1

| | Molecular | | Loading | Capacity | Selectivity- |
|---|---|---|---|---|---|
| Compound | Weight | Selectivity | (%) | (%) | Reabsorption |
| EETB (USP 4,405,585) | 161.24 | 15.4 | 16.3 | 60 | 13.3 |
| Bis-SE (USP 4,405,583) | 216.36 | 16.7 | 28.2 | 80 | 25.2 |
| TMAH | 91.15 | 107.5 | 7.4 | 50.4 | 83.8 |
| TEAH | 147.3 | 70.7 | 6.5 | 53.0 | 102 |
| TPAH | 203.37 | 78.7 | 6.0 | 38.8 | 99.5 |
| TBAH | 259.47 | 35.9 | 8.3 | 39 | 50 |
| TBAH-Sulfuric Acid Salt | 580.99 | 2.75 | 1.7 | — | — |
| TBPH | 259.47 | 78.1 | 2.8 | 60.7 | 101.5 |

NOTE:
The sulfuric acid salt is acidic and therefore not an active absorption agent
for acid gases.
Selectivity = (H₂S/CO₂) in solution/(H₂S/CO₂) in feed gas
Loading = Moles of H₂S/Moles of absorbent Compound
$Capacity = \frac{\begin{matrix}Moles of {H}_{2} S absorbed by absorption solution - Moles of \\ {H}_{2} S remaining after desorption from adsorption solution\end{matrix}}{Moles of {H}_{2} S absorbed by absorption solution}$
Definition of Compound Symbols:
TMAH tetramethyl ammonium hydroxide
TEAH tetraethyl ammonium hydroxide
TPAH tetrapropyl ammonium hydroxide
TBAH tetrabutyl ammonium hydroxide
TBAH sulfuric acid salt is the neutralized sulfate salt
TBPH tetra butyl phosphonium hydroxide

1. A process for the selective removal of one or more gaseous acidic components from a normally gaseous mixture containing said gaseous acidic components and gaseous CO₂ comprising contacting said normally gaseous mixture with an absorbent amino- and/or phosphino compound comprising one or more of tetraorganoammonium salt, one or more of tetraorgano phosphonium salt or a mixture of one or more tetraorganoammonium salt(s) and one or more tetraorganophosphonium salt(s) under conditions whereby one or more gaseous acidic components is selectively absorbed from said mixture.

2. The process of claim 1 wherein the tetraorgano-ammonium salts are of the formula:
[R₄N]⁺X⁻
and the tetraorganophosphorium salts are of the formula:
[R₄P]⁺X⁻
wherein X is hydroxide, carbonate, R¹COO⁻, ArCOO⁻ wherein R¹ is H, C₁₋₉ substituted or unsubstituted alkyl C₃-C₉ substituted or unsubstituted alkenyl, branched alkyl, branched alkenyl, cycloalkyl, C₃-C₉ substituted or unsubstituted hydroxy alkyl or hydroxy cycloalkyl, Ar is C₆ to C₁₄ aryl or alkylaryl or arylalkyl radical and R is the same or different and selected from C₁-C₂₀ substituted or unsubstituted alkyl, C₂-C₂₀ substituted or unsubstituted alkenyl, C₃-C₂₀ substituted or unsubstituted branched chain alkyl, alkenyl, cyclic, cycloalkyl, cycloalkenyl, C₆-C₂₀ substituted or unsubstituted aryl, alkylaryl, arylalkyl, the substitutents, if present, being oxygen containing functional groups.

3. The process of claim 2 wherein the oxygen containing functional group is —OH, —R²OH, —OR³, —R²—O—R³, 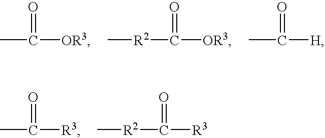
wherein R² and R³ are the same or different and are selected from C₁-C₉ substituted or unsubstituted alkyl, C₃-C₉ substituted or unsubstituted branched alkyl, cyclo alkyl, cycloalkenyl, C₃-C₉ straight or branched alkenyl, C₆-C₂₀ substituted or unsubstituted aryl, alkylaryl or arylalkyl.

4. The process of claim 1, 2 or 3 wherein the gaseous acidic component selectively absorbed from the mixture is H₂S.

5. An absorbent comprising one or more tetraorgano ammonium salt(s), tetraorgano phosphonium salt(s) or mixture thereof.

6. The absorbent of claim 5 wherein the tetraorgano ammonium salts are of the formula
[R₄N]⁺X⁻
and the tetraorganophosphorium salts are of the formula:
[R₄P]⁺X⁻
wherein X is hydroxide, carbonate, R¹COO⁻, ArCOO⁻ wherein R¹ is H, C₁₋₉ substituted or unsubstituted alkyl C₃-C₉ substituted or unsubstituted alkenyl, branched alkyl, branched alkenyl, cycloalkyl, C₃-C₉ substituted or unsubstituted hydroxy alkyl or hydroxy cycloalkyl, Ar is C₆ to C₁₄ aryl or alkylaryl or arylalkyl radical and R is the same or different and selected from C₁-C₂₀ substituted or unsubstituted alkyl, C₂-C₂₀ substituted or unsubstituted alkenyl, C₃-C₂₀ substituted or unsubstituted branched chain alkyl, alkenyl, cyclic, cycloalkyl, cycloalkenyl, C₆-C₂₀ substituted or unsubstituted aryl, alkylaryl, arylalkyl, the substitutents, if present, being oxygen containing functional group(s).

7. The absorbent of claim 6 wherein the oxygen containing functional group is —OH, —R²OH, —OR³, —R²—O—R³, 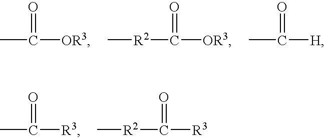
wherein R² and R³ are the same or different and are selected from C₁-C₉ substituted or unsubstituted alkyl, C₃-C₉ substituted or unsubstituted branched alkyl, cycloalkyl, cycloalkenyl, C₃-C₉ substituted or unsubstituted straight or branched alkenyl, C₆-C₂₀ substituted or unsubstituted aryl, alkyl aryl or arylalkyl.
